(19) United States
(12) Patent Application Publication
(10) Pub. No.: US 2009/0209341 A1
(43) Pub. Date: Aug. 20, 2009

(54) Gaming Apparatus Capable of Conversation with Player and Control Method Thereof

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/356,890

(22) Filed: Jan. 21, 2009

Related U.S. Application Data
(60) Provisional application No. 61/028,798, filed on Feb. 14, 2008.

(51) Int. Cl. A63F 9/24; G06F 17/20; G10L 15/04

(52) U.S. Cl. 463/35; 704/8; 704/251; 704/E15.003; 704/E15.004

(57) ABSTRACT

A gaming apparatus of the present invention comprises: a microphone; a speaker; a display; a memory storing text data for each language type; and a controller. The controller is programmed to conduct the processing of: (A) recognizing a language type from a sound inputted from the microphone by executing a language recognition program; (B) conducting a conversation with a player by recognizing a voice inputted from the microphone, in addition to outputting a voice from the speaker by executing a conversation program corresponding to the language recognized in the processing (A); and (C) displaying to the display a text based on text data corresponding to the language type recognized in the processing (A) according to progress of a game, the text data being read from the memory.

### CROSS-REFERENCE TO RELATED APPLICATIONS

This application claims priority of U.S. Provisional Application No. 61/028,798 filed on Feb. 14, 2008. The contents of this application are incorporated herein by reference in their entirety.

### BACKGROUND OF THE INVENTION

1. Field of the Invention

The present invention relates to a gaming apparatus capable of conducting a conversation with a player by executing a conversation program and a control method thereof.

2. Discussion of the Background

Conventionally, there exists a technology relating to a conversation program which enables recognition of a content of a voice inputted from a microphone and output of a voice response corresponding to the content. Technologies of this kind are disclosed in, for example, US 2007/0094007-A1, US 2007/0094008-A1, US 2007/0094005-A1, US 2007/0094004-A1 and US 2007/0033040-A1.

Objects of the present invention are to provide a sophisticated service by installing a conversation program of this kind on a gaming apparatus, and to provide a gaming apparatus which enables solving a problem newly generated in the case that a conversation program is installed on a gaming apparatus and a control method thereof.

The contents of US 2007/0094007-A1, US 2007/0094008-A1, US 2007/0094005-A1, US 2007/0094004-A1 and US 2007/0033040-A1 are incorporated herein by reference in their entirety.

### SUMMARY OF THE INVENTION

The present invention provides a gaming apparatus having the following configuration.

Namely, the gaming apparatus includes a microphone; a speaker; a display; a memory storing text data for each language type; and a controller. The controller is programmed to conduct the processing of: (A) recognizing a language type from a sound inputted from the microphone by executing a language recognition program; (B) conducting a conversation with a player by recognizing a voice inputted from the microphone, in addition to outputting a voice from the speaker by executing a conversation program corresponding to the language recognized in the processing (A); and (C) displaying to the display an image based on text data corresponding to the language type recognized in the processing (A) according to progress of a game, the text data read from the memory.

According to the gaming apparatus, the language type is recognized from a sound inputted from the microphone. Further, according to a progress of a game, text data corresponding to the recognized language type is read from the memory and a text based on the text data is displayed to the display. Namely, a text recognizable to a player is displayed to the display according to the progress of the game. Accordingly, compared to a case where a text in an unrecognizable language for the player is displayed, the player can understand more the progress of the game and a content of a game effect, so that the player can enjoy the game more.

Further, a conversation with the player is conducted based on the execution of a conversation program corresponding to the recognized language. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness.

As above described, according to the gaming apparatus, it becomes possible to provide a sophisticated service by installing a conversation program on a gaming apparatus.

Further, in the case that a conversation program is installed on a gaming apparatus, a problem is how to specify the language type. However, according to the gaming apparatus, the language type is recognized from a sound inputted from the microphone, so that a conversation can be started smoothly. Particularly, it is possible to surprise a player who does not know that a conversation is to be conducted, by talking to suddenly.

Furthermore, the gaming apparatus desirably comprises the following configuration.

The controller is further programmed to conduct the processing of (D) measuring a time period between the output of the voice relating to the conversation from the speaker and an input of a response to the microphone, and the processing (B) is processing of conducting the conversation with the player by recognizing a voice inputted from the microphone, in addition to outputting a voice at a speed corresponding to the time period measured in the processing (D).

Generally, young people tend to prefer fast-paced conversations and elder people tend to prefer slow-paced conversations. According to the gaming apparatus, a time period between the output of the voice relating to the conversation from the speaker and the input of a response thereto to the microphone is measured. A voice at a speed corresponding to the measured time period is outputted, and the conversation with the player is conducted by recognizing a voice inputted from the microphone. As above described, a conversation is conducted at a speed corresponding to the conversation speed of the player, and therefore, the player can enjoy a more comfortable conversation.

The present invention further provides a gaming apparatus having the following configuration.

Namely, the gaming apparatus comprises a microphone; a speaker; a display; a memory storing text data for each language type; an input device; and a controller. The controller is programmed to conduct the processing of: (A) recognizing a language type by an input from the input device; (B) conducting a conversation with a player by recognizing a voice inputted from the microphone, in addition to outputting a voice from the speaker by executing a conversation program corresponding to the language recognized in the processing (A); and (C) displaying to the display an image based on text data corresponding to the language type recognized in the processing (A) according to progress of a game, the text data read from the memory.

According to the gaming apparatus, the language type is recognized by an input from the input device. Further, according to a progress of a game, text data corresponding to the recognized language type is read from the memory and a text based on the text data is displayed to the display. Namely, a text recognizable to a player is displayed to the display according to the progress of the game. Accordingly, compared to a case where a text in an unrecognizable language for the player is displayed, the player can understand more the progress of the game and a content of a game effect, so that the player can enjoy the game more.

Further, a conversation with the player is conducted based on the execution of a conversation program corresponding to the recognized language. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness. As above described, according to the gaming apparatus, it becomes possible to provide a sophisticated service by installing a conversation program on a gaming apparatus.

Furthermore, in the case that a conversation program is installed on a gaming apparatus, a problem is how to specify the language type. However, according to the gaming apparatus, a language type is recognized by an input from the input device, so that a possibility of starting a conversation in a language that the player cannot understand is extremely low.

Furthermore, the gaming apparatus desirably comprises the following configuration.

The controller is further programmed to conduct the processing of (D) measuring a time period between the output of the voice relating to the conversation from the speaker and an input of a response to the microphone, and the processing (B) is processing of conducting the conversation with the player by recognizing a voice inputted from the microphone, in addition to outputting a voice at a speed corresponding to the time period measured in the processing (D).

According to the gaming apparatus, a time period between the output of the voice relating to the conversation from the speaker and the input of a response to the microphone is measured. A voice at a speed corresponding to the measured time period is outputted, and the conversation with the player is conducted by recognizing a voice inputted from the microphone. As above described, a conversation is conducted at a speed corresponding to the conversation speed of the player, and therefore, the player can enjoy a more comfortable conversation.

Further, the present invention provides a control method of the gaming apparatus having the following configuration.

Namely, the control method of a gaming apparatus comprises the step of: (A) recognizing a language type from a sound inputted from a microphone by executing a language recognition program; (B) conducting a conversation with a player by recognizing a voice inputted from the microphone, in addition to outputting a voice from a speaker by executing a conversation program corresponding to the language recognized in the step (A); and (C) displaying to a display a text corresponding to the language type recognized in the step (A) according to progress of a game.

According to the control method of the gaming apparatus, the language type is recognized from a sound inputted from the microphone. Further, according to progress of the game, text data corresponding to the recognized language type is read from the memory and a text based on the text data is displayed to the display. Namely, a text recognizable to a player is displayed to the display according to the progress of the game. Accordingly, compared to a case where a text in an unrecognizable language for the player is displayed, the player can understand more the progress of the game and a content of a game effect, so that the player can enjoy the game more.

Further, a conversation with the player is conducted based on the execution of a conversation program corresponding to the recognized language. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness.

As above described, according to the control method of the gaming apparatus, it becomes possible to provide a sophisticated service by installing a conversation program on a gaming apparatus.

Further, in the case that a conversation program is installed on a gaming apparatus, a problem is how to specify the language type. However, according to the control method of the gaming apparatus, the language type is recognized from a sound inputted from the microphone, so that a conversation can be started smoothly. Particularly, it is possible to surprise a player who does not know that a conversation is to be conducted, by talking to suddenly.

Further, the present invention provides a control method of the gaming apparatus having the following configuration.

Namely, a control method of a gaming apparatus comprises the step of: (A) recognizing a language type by an input from the input device; (B) conducting a conversation with a player by recognizing a voice inputted from a microphone, in addition to outputting a voice from a speaker by executing a conversation program corresponding to the language recognized in the step (A); and (C) displaying to a display a text corresponding to the language type recognized in the step (A) according to progress of a game.

According to the control method of the gaming apparatus, the language type is recognized by an input from the input device. Further, according to progress of the game, text data corresponding to the recognized language type is read from the memory and a text based on the text data is displayed to the display. Namely, a text recognizable to a player is displayed to the display according to the progress of the game. Accordingly, compared to a case where a text in an unrecognizable language for the player is displayed, the player can understand more the progress of the game and a content of a game effect, so that the player can enjoy the game more.

Further, a conversation with the player is conducted based on the execution of a conversation program corresponding to the recognized language. Therefore, it becomes possible for the player to play a game while enjoying the conversation. Particularly, on a gaming apparatus providing a game played by a single player (game not advanced by cooperation with another player), it is highly possible that the player feels loneliness. However, by conducting a conversation, it becomes possible to dispel the loneliness. As above described, according to the control method of the gaming apparatus, it becomes possible to provide a sophisticated service by installing a conversation program on a gaming apparatus.

Furthermore, in the case that a conversation program is installed on a gaming apparatus, a problem is how to specify the language type. However, according to the control method of the gaming apparatus, a language type is recognized by an input from the input device, so that a possibility of starting a conversation in a language that the player cannot understand is extremely low.

As above described, according to the present invention, it is possible to provide a sophisticated service by installing a conversation program on a gaming apparatus, and to provide a gaming apparatus which enables solving of a problem newly generated in the case that a conversation program is installed on a gaming apparatus and a control method thereof.

### BRIEF DESCRIPTION OF THE DRAWINGS

FIG. 1 is a flow chart illustrating an outline of game processing conducted in a gaming apparatus according to one embodiment of the present invention.

FIG. 2 is an external view schematically showing a gaming system according to one embodiment of the present invention.

FIG. 3 is a block diagram illustrating an internal configuration of the gaming system shown in FIG. 2.

FIG. 4 is an exemplary view of an image displayed to a front display connected with a central controller.

FIG. 5 is a perspective view schematically showing the gaming apparatus shown in FIG. 2.

FIG. 6 is a block diagram illustrating an internal configuration of the gaming apparatus shown in FIG. 5.

FIG. 7 is an explanatory view of a storage area of a RAM provided in the gaming apparatus shown in FIG. 5.

FIG. 8 is an exemplary view of a GRADE image selection table.

FIG. 9 is an exemplary view of a conversation speed determination table.

FIG. 10 is an exemplary view of a displayable-or-not determination table.

FIG. 11 is an exemplary view of a conversational sentence selection table.

FIG. 12A is an exemplary view of an image displayed to a liquid crystal display provided in the gaming apparatus shown in FIG. 5.

FIG. 12B is another exemplary view of an image displayed to the liquid crystal display provided in the gaming apparatus shown in FIG. 5.

FIG. 13 is a flow chart illustrating game processing according to the present embodiment.

FIG. 14 is a flow chart illustrating game processing according to the present embodiment.

FIG. 15 is a flow chart illustrating game processing according to the present embodiment.

FIG. 16 is a flow chart illustrating game processing according to the present embodiment.

FIG. 17 is a flow chart illustrating game processing according to the present embodiment.

FIG. 18 is a flow chart illustrating game processing according to the present embodiment.

FIG. 19 is a flow chart illustrating language type recognition processing according to the present embodiment.

FIG. 20 is a flow chart illustrating language type recognition processing according to the present embodiment.

FIG. 21 is an exemplary view showing an image displayed to the liquid crystal display included in the gaming apparatus shown in FIG. 5.

FIG. 22 is a flow chart illustrating belief estimation processing according to the present embodiment.

FIG. 23 is a flow chart illustrating conversation processing according to the present embodiment.

### DESCRIPTION OF THE EMBODIMENTS

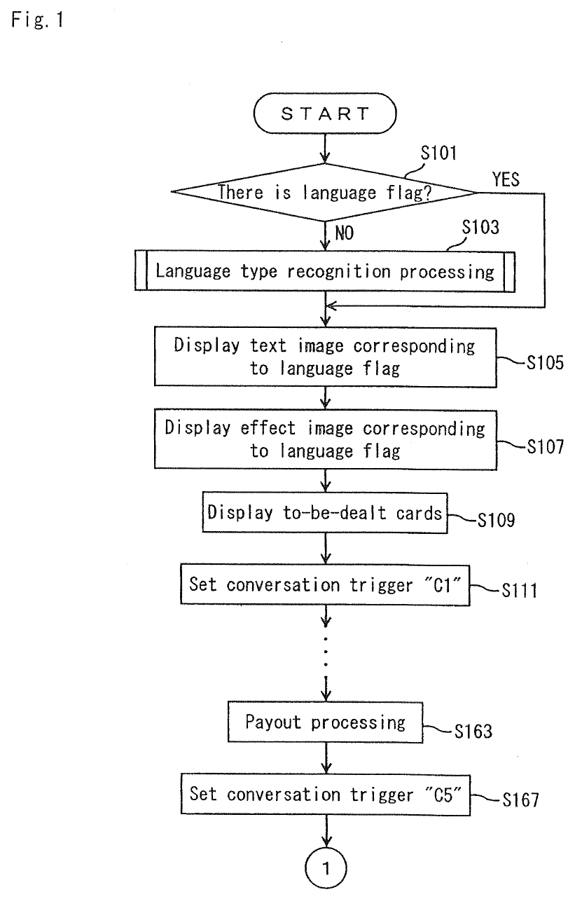

First, there will be described an outline of game processing conducted in a gaming apparatus according to an embodiment of the present invention with reference to FIG. 1.

FIG. 1 is a flow chart illustrating the outline of the game processing conducted in the gaming apparatus according to an embodiment of the present invention.

In the present embodiment, there will be described a case where Hold'em poker is played as a game. A rule of the Hold'em poker will be described later. Here, a type of the game conducted in the present invention is not particularly limited.

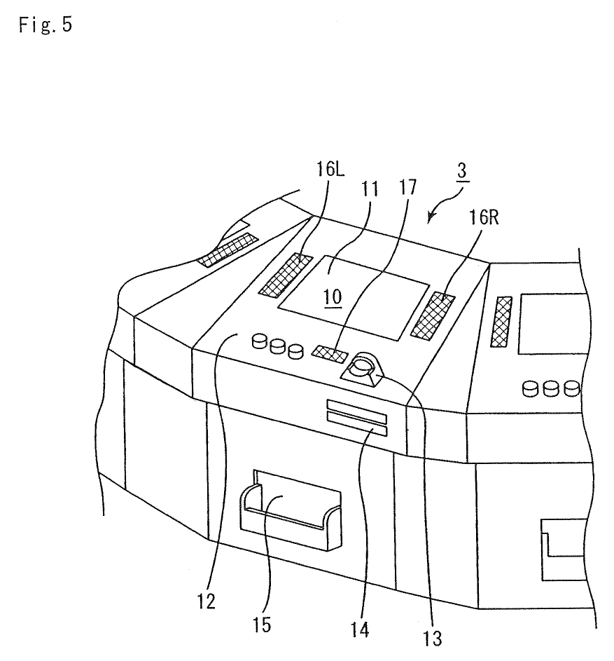

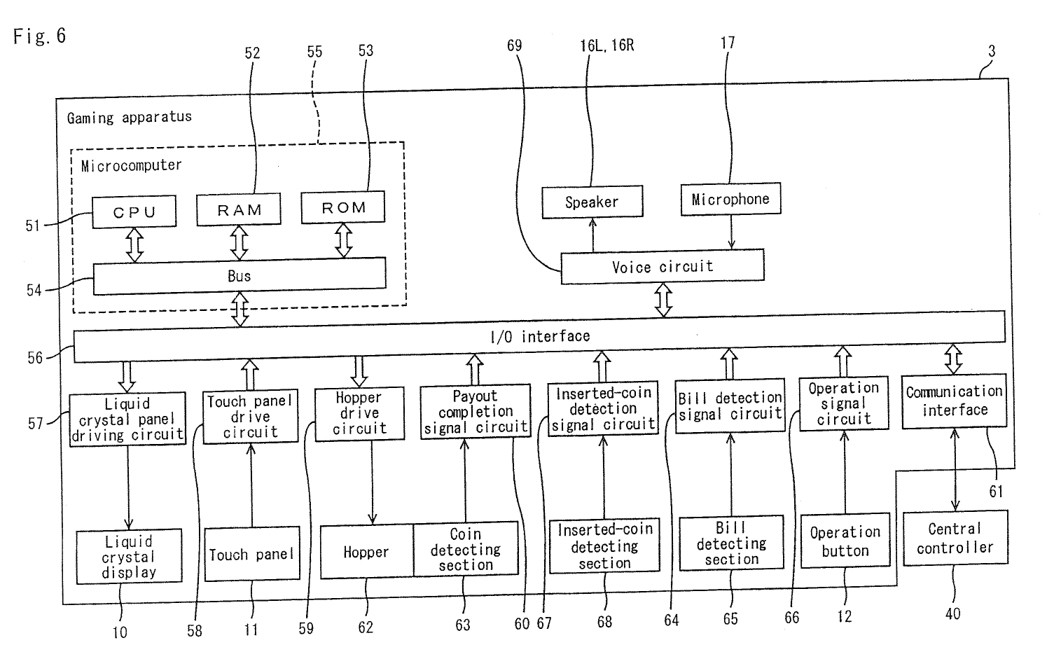

CPU 51 (see FIG. 6) provided in a gaming apparatus 3 firstly determines, when a game is started, whether or not a language flag is set (step S101). The language flag is an indicator to determine a language to which an effect image or a text image to be displayed to a liquid crystal display 10 is corresponding (see FIG. 5).

When determining that the language flag is not set, the CPU 51 conducts language type recognition processing (step S103). In the processing, The CPU 51 outputs various languages such as English and Japanese from speakers 16 (see FIG. 5) one by one. Then, the CPU 51 determines to which language there is a response from a microphone 17 (see FIG. 5), and thereby determining a language type. Thereafter, a language flag corresponding to the determined language type is set in a RAM 52.

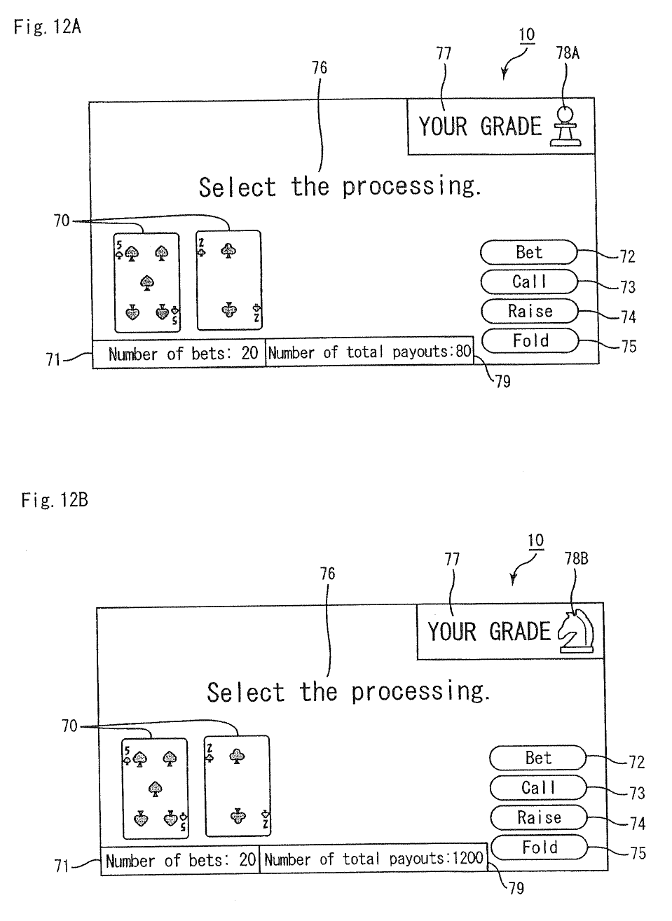

When determining that the language flag is set, or after conducting the processing of step S103, the CPU 51 displays a text image corresponding to the language flag to the liquid crystal display 10 (step S105). In the processing, for example, the CPU 51 displays a text image 77 (for example, see FIG. 12A) in English in the case that the language flag is “English”, and displays a text image in Japanese in the case that the language flag is “Japanese”.

Next, in step S107, the CPU 51 displays an effect image corresponding to the language flag to the liquid crystal display 10. In the processing, for example, the CPU 51 displays an image of a chess piece (for example, see GRADE image 78A in FIG. 12A) in the case that the language flag is “English”, and displays an image of a shogi piece in the case that the language flag is “Japanese”. Here, shogi is a board game widely known in Japan.

Next, in step S109, the CPU 51 displays a to-be-dealt card to the liquid crystal display 10. The to-be-dealt card is a card dealt to a player in Hold'em poker.

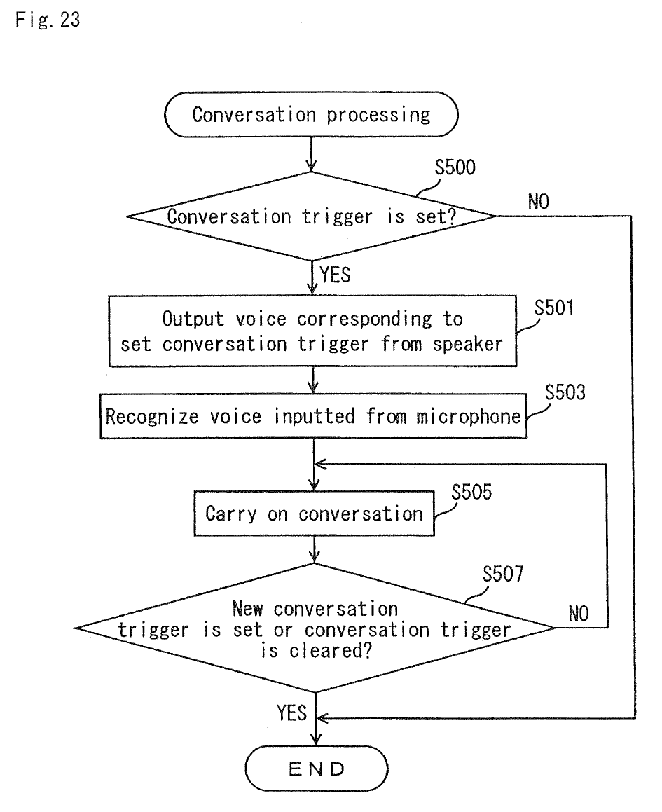

Next, in step S111, the CPU 51 sets a conversation trigger C1 in the RAM 52. The conversation trigger C1 is a trigger indicating that the to-be-dealt card is displayed and being an indicator to start conversation. As a result of the conversation trigger C1 being set in the RAM 52, a conversation based on the to-be-dealt card being dealt is started in the gaming apparatus 3 (see steps S500 and S501 in FIG. 23). For example, a conversational sentence such as “How's it going today?” and “Good luck to you.” is outputted from the speakers 16, so that the conversation is started. Here, the conversation is conducted in the language corresponding to the set language flag.

Thereafter, processing relating to progress of the game such as processing to bet a coin and processing to open a card in dealer's hand is conducted. During this period too, for each predetermined processing being conducted, a conversation trigger corresponding to each processing is set. This causes the conversation based on each processing started.

Then, in step S163, the CPU 51 conducts payout processing. In this processing, the CPU 51 pays out a predetermined number of coins from a coin payout exit 15 (see FIG. 5), in the case that the strongest hand is established.

Next, in step S167, the CPU 51 sets a conversation trigger C5 in the RAM 52. The conversation trigger C5 is a trigger indicating that a single game is ended and being an indicator to start the conversation. As a result of the conversation trigger C5 being set in the RAM 52, a conversation based on the single game being ended is started in the gaming apparatus 3 (see steps S500 and S501 in FIG. 23). For example, a conversational sentence is outputted from the speakers 16, for example, “You seem to have a run of luck today.” in the case that a coin is paid out and “Too bad.” in the case that a coin is not paid out, so that the conversation is started. Thereafter, the present game processing is terminated.

According to the gaming apparatus 3, a language type is recognized from a sound inputted from the microphone 17. Then, according to the progress of the game, a text image corresponding to the recognized language type is displayed to the liquid crystal display 10. Namely, a text recognizable to a player is displayed to the liquid crystal display 10 according to the progress of the game. Accordingly, compared to a case where a text in an unrecognizable language for the player is displayed, the player can understand more the progress of the game and a content of a game effect, so that the player can enjoy the game more.

Further, the conversation is conducted in the recognized language, and therefore, it becomes possible for the player to play the game while enjoying the conversation. Particularly, on the gaming apparatus 3 providing a game played by a single player (game not advanced by cooperation with another player) as in the present embodiment, it is highly possible that the player feels loneliness. However, by conducting a conversation, it becomes possible to dispel the loneliness.

As above described, according to the gaming apparatus 3, it becomes possible to provide a sophisticated service by installing a conversation program on a gaming apparatus.

Furthermore, in the case that a conversation program is installed on the gaming apparatus 3, a problem is how to specify the language type. However, according to the gaming apparatus 3, a language type is recognized from a sound inputted from the microphone 17, so that a conversation can be started smoothly. Particularly, it is possible to surprise a player who does not know that a conversation is to be conducted, by talking to suddenly.

Next, there will be described a gaming system according to an embodiment of the present invention in detail.

In a gaming system 1 according to the present embodiment, Hold'em poker is played as a game.

Here, a rule of Hold'em poker is described.

In Hold'em poker, a deck of playing cards (52 cards) except a joker is used.

First, a dealer deals two cards to each player. Each player selects an action after seeing the dealt cards, out of betting a coin (hereinafter, also simply refers to as “bet”), betting the same amount of coins as a bet amount of a previous player (hereinafter, also refers to as “call”), increasing a betting amount (hereinafter, also refers to as “raise”) and terminating the game without betting (hereinafter, also refers to as “fold”). In the following, this selection is referred to as a bet selection.

Next, the dealer opens three cards (called Flop) out of cards in hand. In the gaming system 1 according to the present embodiment, the Flop is displayed to a front display 21, as later described. Here, each player conducts the bet selection.

The dealer opens the fourth card (called Turn). Each player conducts the bet selection.

The dealer opens the fifth card (called River). Each player conducts the bet selection.

Then, all the cards (cards dealt at the beginning) in hands of the players remaining in the game are opened (called showdown), and then, each player forms a hand by combining two cards in hand and three cards out of five dealer's cards. Hands of the respective players are compared and all the betted coins are provided to the player who has established the strongest hand.

As hands in Hold'em poker, there are Royal Flush, Straight Flush, Four of a Kind, Full House, Flush, Straight, Three of a Kind, Two pair, One pair and No Pair, in the order of strength.

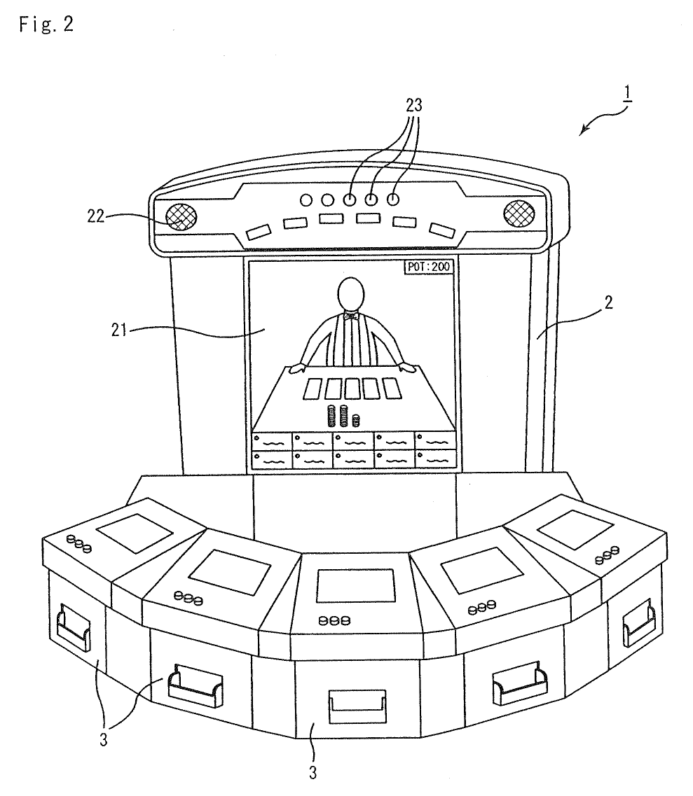

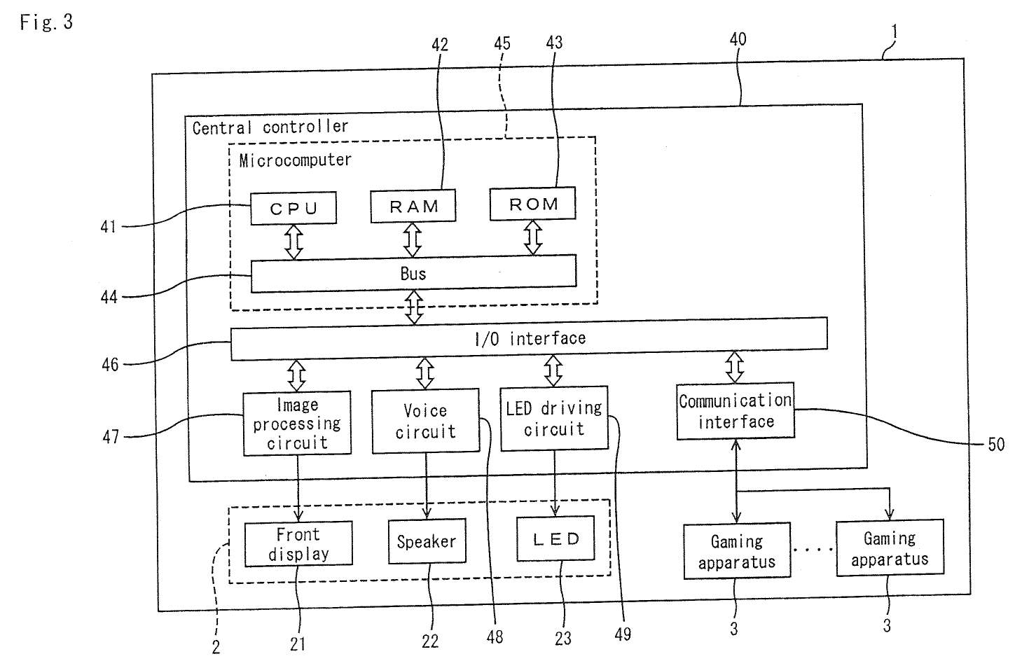

FIG. 2 is an external view schematically showing a gaming system according to one embodiment of the present invention. FIG. 3 is a block diagram illustrating an internal configuration of the gaming system shown in FIG. 2. Here, while the gaming apparatus 3 according to the present embodiment is connected to a network, the present invention is also applicable to a stand-alone type gaming apparatus which is not connected to a network.

The gaming system 1 according to the present embodiment is equipped with five gaming apparatuses 3 and a central controller 40 and a monitor 2. The monitor 2 is equipped with: a front display 21 for displaying an image of a dealer, information about each player's game (hereinafter, also referred to as gaming information) and the like; speakers 22 placed above the front display 21, for outputting music or an effect sound along with progress of the game; and LEDs 23 lighted when various types of effects are produced.

The central controller 40 basically comprises a microcomputer 45 as a core, which includes a CPU 41, a RAM 42, a ROM 43 and a BUS 44 for transferring data mutually among these devices.

The ROM 43 stores various types of programs for conducting processing necessary for controlling the gaming system 1, a data table and the like. Further, the RAM 42 is a memory for temporarily storing various types of data calculated in the CPU 41.

The CPU 41 is connected through an I/O interface 46 with an image processing circuit 47, a voice circuit 48, a LED drive circuit 49 and a communication interface 50. The front display 21 is connected with the image processing circuit 47. The speakers 22 are connected with the voice circuit 48. The LEDs 23 are connected with the LED drive circuit 49. Five gaming apparatuses 3 are connected with the communication interface 50. The central controller 40 controls output of a signal relating to an image to be displayed to the front display 21, and driving of the speakers 22 and the LEDs 23.

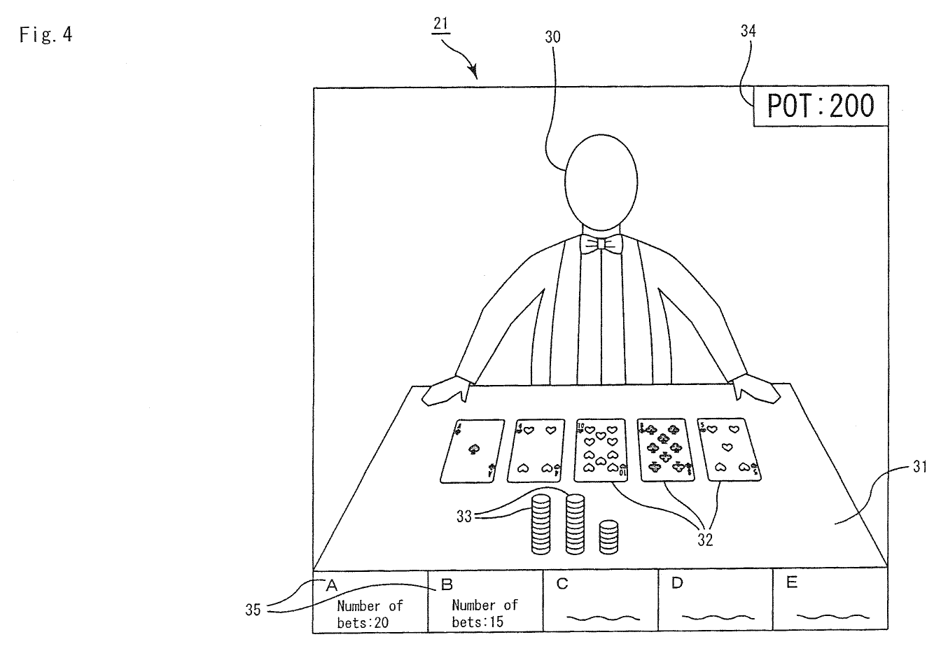

FIG. 4 is an exemplary view of an image displayed to a front display.

As illustrated in FIG. 4, a dealer 30 is displayed to a virtually central part of the front display 21.

Below the dealer 30, a table 31 is displayed. On the table 31, there are displayed five card images 32 indicating five cards and a coin image 33 indicating betted coins.

Further, below the table 31, there are provided gaming information display portions 35 for displaying respective players' gaming information. Alphabets A to E displayed to the gaming information display portions 35 correspond to the respective gaming apparatuses 3. To each of the gaming information display portions 35, there is displayed the gaming information of the player on the corresponding gaming apparatus 3.

The gaming information includes information on the number of bets placed until now and a bet selection of each player. Further, in the case of showdown, cards dealt to each player at the beginning of the game are displayed to the gaming information display portion 35.

Here, in the case that there is a gaming apparatus 3 not used for the game, the gaming information of the player having a turn to select a bet is displayed to the gaming information display portion 35 corresponding to the gaming apparatus 3.

At the upper right end part of the front display 21, there is provided a POT display portion 34 for displaying a total sum of coins betted at the moment.

FIG. 5 is a perspective view schematically showing the gaming apparatus shown in FIG. 2.

As illustrated in FIG. 5, the gaming apparatus 3 is equipped with a liquid crystal display 10 for displaying an image related to a later-described operation (see FIG. 12A), a result of a game and the like, in the virtually center portion of the upper face thereof. The liquid crystal display 10 corresponds to the display according to the present invention. On the upper face of the liquid crystal display 10, there is provided a touch panel 11 with which a player inputs an operation. In front of the liquid crystal display 10, there are provided an operation button 12 with which a payout operation is performed, a coin insertion slot 13 to which a coin or a medal is inserted and a microphone 17 for picking up a voice of the player. On both sides of the liquid crystal display 10, there are provided speakers 16 (speaker 16L, speaker 16R). The microphone 17 corresponds to the microphone according to the present invention. The speakers 16 correspond to the speaker of the present invention. Further, at the upper right end of the front face of the gaming apparatus 3, there is provided a bill insertion slot 14 to which a bill is inserted. Below the bill insertion slot 14, there is provided a coin payout exit 15 for paying out to the player a coin or a medal corresponding to the accumulated credit when the payout operation is conducted.

Next, there will be described an internal configuration of the gaming apparatus 3.

FIG. 6 is a block diagram illustrating an internal configuration of a gaming apparatus according to the present embodiment.

As illustrated in FIG. 6, the gaming apparatus 3 basically comprises a microcomputer 55 as a core, which includes the CPU 51, the RAM 52, a ROM 53 and a BUS 54 for transferring data mutually among these devices.

The ROM 53 stores various types of programs for conducting processing necessary for controlling the gaming apparatus 3, a data table and the like. Particularly, the ROM 53 stores a language recognition program for recognizing a language type and a conversation program for conducting a conversation with a player. As the language recognition program and the conversation program, conventionally known programs may be adopted. Here, the language recognition program and the conversation program are disclosed in US 2007/0094007-A1, US 2007/0094008-A1, US 2007/0094005-A1, US 2007/0094004-A1 and US 2007/0033040-A1, and therefore, detailed descriptions thereof are omitted here.

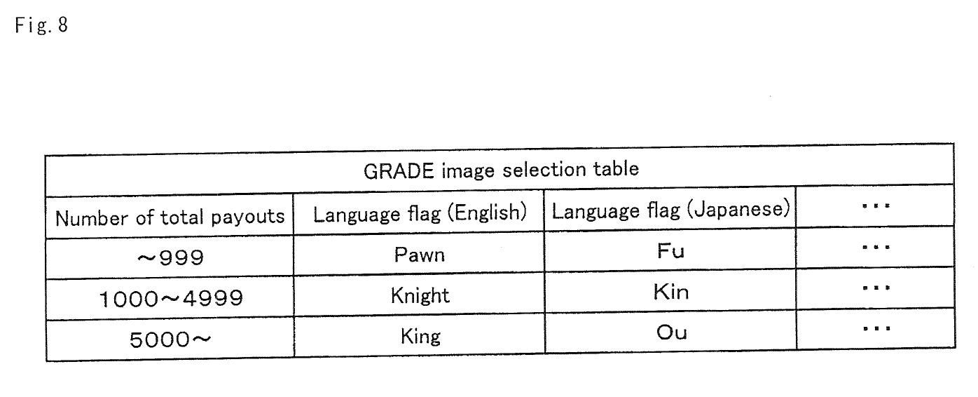

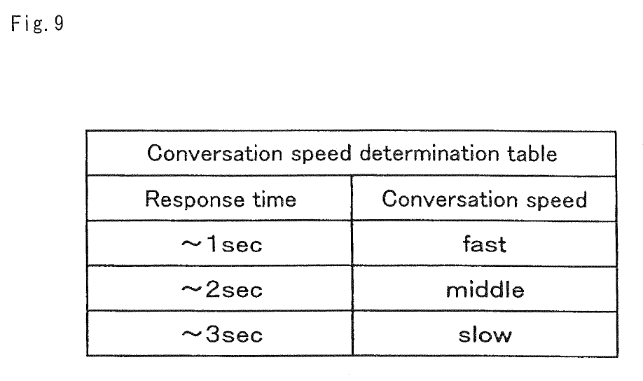

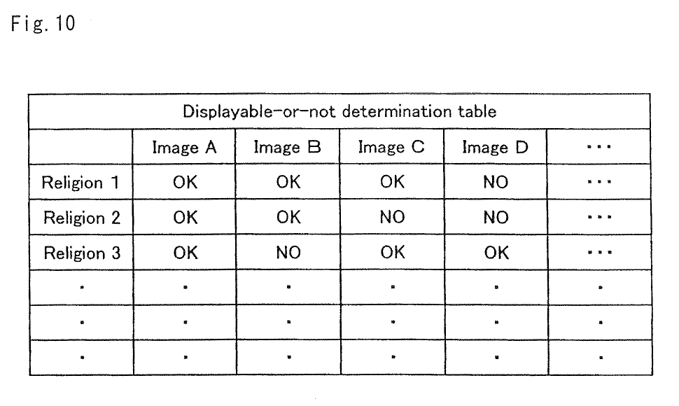

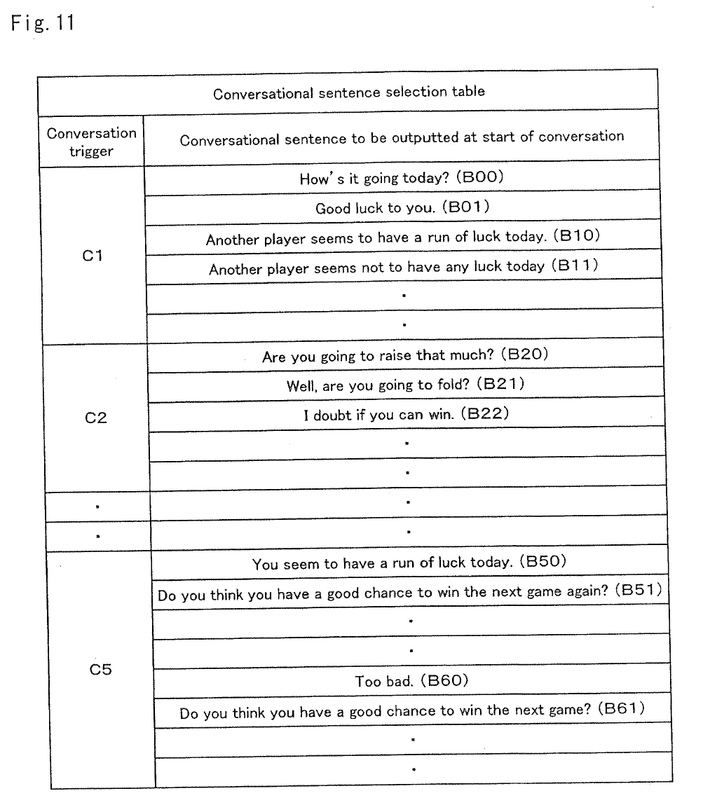

Further, the ROM 53 particularly stores a GRADE image selection table (see FIG. 8), a conversation speed determination table (see FIG. 9), a displayable-or-not determination table (see FIG. 10) and a conversational sentence selection table (see FIG. 11). Here, details of these tables will be described later. Furthermore, the ROM 53 stores image data such as a text image and a language selection image corresponding to the language type. The image data of a text image corresponds to the text data according to the present invention. The ROM 53 further stores effect image data, which is for displaying a GRADE image and corresponding to the language type. The ROM 53 corresponds to the memory according to the present invention. The GRADE image corresponds to the effect image according to the present invention. Moreover, the CPU 51, the RAM 52 and the ROM 53 configure the controller of the present invention.

The RAM 52 is a memory capable of temporarily storing the number of credits accumulated in the gaming apparatus 3 at the moment and a various types of data calculated in the CPU 51.

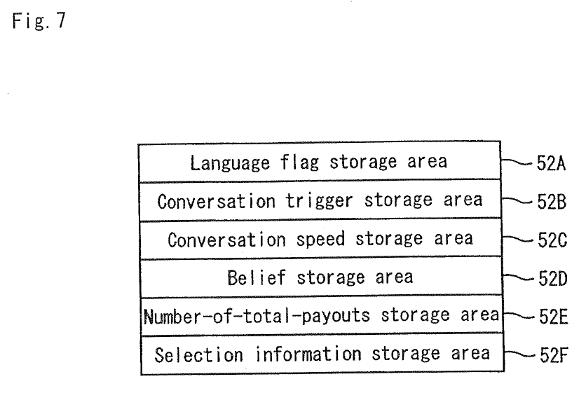

FIG. 7 is an explanatory view of a storage area of a RAM provided in the gaming apparatus shown in FIG. 5.

As illustrated in FIG. 7, the RAM 52 is particularly provided with a language flag storage area 52A for storing a language flag, a conversation trigger storage area 52B for storing a conversation trigger, a conversation speed storage area 52C for storing information on conversation speed, a belief storage area 52D for storing information on an estimated belief of a player, a number-of-total-payouts storage area 52E for storing the number of total payouts and a selection information storage area 52F for storing information on bet selection (hereinafter, also referred to as “selection information”).

The number of total payouts refers to the number of coin-outs cumulatively accumulated in the games of a plurality of times, and it is cumulatively accumulated until the number of credits becomes zero, and is reset to zero when the number of credits becomes zero.

Further, as illustrated in FIG. 6, the CPU 51 is connected through an I/O interface 56 with a liquid crystal panel drive circuit 57, a touch panel drive circuit 58, a hopper drive circuit 59, a payout completion signal circuit 60, an inserted-coin detection signal circuit 67, a bill detection signal circuit 64, an operation signal circuit 66, a communication interface 61 and a voice circuit 69.

The liquid crystal display 10 is connected with the liquid crystal panel drive circuit 57. The touch panel 11 is connected with the touch panel drive circuit 58. A hopper 62 is connected with the hopper drive circuit 59. A coin detecting section 63 is connected with the payout completion signal circuit 60. An inserted-coin detecting section 68 is connected with the inserted-coin detection signal circuit 67. A bill detecting section 65 is connected with the bill detection signal circuit 64. The operation button 12 is connected with the operation signal circuit 66. The speakers 16 and the microphone 17 are connected with the voice circuit 69.

The hopper 62 is provided inside the gaming apparatus 3 and pays out a coin from the coin payout exit 15 based on a control signal outputted from the CPU 51.

The coin detecting section 63 is provided inside the coin payout exit 15 and transmits a signal to the CPU 51 on detecting a predetermined number of coins being paid out through the coin payout exit 15.

The inserted-coin detecting section 68, on detecting a coin being inserted from the coin insertion slot 13, detects the value of the coin and transmits to the CPU 51 a detection signal indicating the detected value.

The bill detecting section 65, on accepting a bill, detects the value of the bill and transmits to the CPU 51 a detection signal indicating the detected value.

The operation button 12 is a button with which a payout operation is performed in the case that a payout of a coin is determined.

FIG. 8 is an exemplary view of a GRADE image selection table.

As illustrated in FIG. 8, the GRADE image is determined based on a combination of the number of total payouts and the language flag. For example, in the case that the language flag is “English” and the number of total payouts is 999 or less, “Pawn” is selected as the GRADE image. Further, in the case that the language flag is “English” and the number of total payouts is in the range of 1000 to 4999, “Knight” is selected as the GRADE image. Furthermore, in the case that the language flag is “English” and the number of total payouts is 5000 or more, “King” is selected as the GRADE image.

On the other hand, for example, in the case that the language flag is “Japanese” and the number of total payouts is 999 or less, “Fu” is selected as the GRADE image. Further, in the case that the language flag is “Japanese” and the number of total payouts in the range of 1000 to 4999, “Kin” is selected as the GRADE image. Furthermore, in the case that the language flag is “Japanese” and the number of total payouts is 5000 or more, “Ou” is selected as the GRADE image.

The GRADE image in the present embodiment corresponds to the effect image according to the present invention.

FIG. 9 is an exemplary view of a conversation speed determination table.

As illustrated in FIG. 9, the conversation speed is determined according to the response time between the output of the voice relating to the conversation from the speakers 16 and the input of a response thereto from the microphone 17. For example, in the case that the response time is one second or less, the conversation speed is determined to be “fast”. Further, in the case that the response time is over one second and not over two seconds, the conversation speed is determined to be “middle”. Furthermore, the response time is over two seconds and not over three seconds, the conversation speed is determined to be “slow”.

FIG. 10 is an exemplary view of a displayable-or-not determination table.

As illustrated in FIG. 10, in the displayable-or-not determination table, each religion is related to whether or not respective images (image A, image B, image C and image D) are displayable. For example, religion 1 is related to “OK” with respect to the display of the image A, the image B and the image C, and is related to “NO” with respect to the display of the image D.

FIG. 11 is an exemplary view of a conversational sentence selection table.

As illustrated in FIG. 11, a conversational sentence outputted at the start of a conversation is stored in a state being related to the conversation trigger. In the present embodiment, a plurality of conversational sentences are related to a single type of conversation trigger.

A conversation trigger C1 is a trigger set in the RAM 52 when the to-be-dealt cards are displayed.

A conversation trigger C2 is a trigger set in the RAM 52 when the player takes an action out of bet, call, raise and fold, after to-be-dealt cards are displayed.

A conversation trigger C3 is a trigger set in the RAM 52 when the player takes an action out of bet, call, raise and fold, after Flop is displayed.

A conversation trigger C4 is a trigger set in the RAM 52 when the player takes an action out of bet, call, raise and fold, after Turn is displayed.

A conversation trigger C5 is a trigger set in the RAM 52 when a single game is ended.

In the case that the conversation trigger C1 is set, the CPU 51 determines a single conversational sentence as a to-be-outputted conversational sentence by selecting a random number, out of general conversational sentences (for example, a conversational sentence B00 and a conversational sentence B01) and conversational sentences based on a gaming history on another gaming apparatus 3 (for example, a conversational sentence B10 and a conversational sentence B11). Here, the gaming history on another gaming apparatus 3 is received from the central controller 40 at a predetermined timing (for example, every time a single game is ended). Examples of the gaming history received from the central controller 40 include the number of coins paid out in each gaming apparatus 3.

In the case that the conversation trigger C2 is set, the CPU 51 refers to the selection information and determines a conversational sentence corresponding to the selection information as a to-be-outputted conversational sentence. For example, the CPU 51 selects a conversational sentence B20 in the case that the selection information is “raise”, a conversational sentence B21 in the case that the selection information is “fold”, and a conversational sentence B22 in the case that the selection information is other than “raise” and “fold”, as a to-be-outputted conversational sentence.

In the case that the conversation trigger C5 is set, the CPU 51 determines whether or not a payout has been conducted and determines a conversational sentence corresponding to the determination result as a to-be-outputted conversational sentence. For example, when determining that a payout has been conducted, the CPU 51 determines a single conversational sentence out of conversational sentences B50 and B51, as a to-be-outputted conversational sentence. Further, when determining that a payout has not been conducted, the CPU 51 determines a single conversational sentence out of conversational sentences B60 and B61, as a to-be-outputted conversational sentence.

FIG. 12A and FIG. 12B are exemplary views of images displayed to a liquid crystal display provided in a gaming apparatus.

Here, images shown in FIG. 12A and FIG. 12B are images displayed to the liquid crystal display in the case that “English” is set as the language flag.

As illustrated in FIG. 12A, to the upper right side of the liquid crystal display 10, the text image 77 (text 77) showing “YOUR GRADE” and the GRADE image 78A showing a Pawn piece of chess are displayed.

In the left side of the liquid crystal display 10, two card images 70 showing two cards to be dealt to the player at the beginning of the game are displayed.

Under the card images 70, there are provided a number-of-bets display portion 71 for displaying the number of bets of the player at the moment and a number-of-total-payouts display portion 79 for displaying the total number of coins paid out to the player in the past games, starting from the left.

In the right side of the liquid crystal display 10, there are provided a bet selecting portion 72 for selecting “bet”, a call selecting portion 73 for selecting “call”, a raise selecting portion 74 for selecting “raise” and a fold selecting portion 75 for selecting “fold”, when a bet selection is conducted. The player can conduct a bet selection by touching a part corresponding to each selecting portion on the touch panel 11.

To the center part of the liquid crystal display 10, there is displayed an instruction image 76 showing “Select the processing.” to prompt the player to conduct a bet selection.

In the case that the number of total payouts is 999 or less, as illustrated in FIG. 12A, the GRADE image 78A showing the Pawn piece is displayed as the GRADE image. On the other hand, in the case that the number of total payouts is in the range of 1000 to 4999, as illustrated in FIG. 12B, a GRADE image 78B showing a Knight piece is displayed as the GRADE image. Further, although not shown, in the case that the number of total payouts is 5000 or more, a GRADE image showing a King piece is displayed as the GRADE image.

Next, there will be described game processing conducted in the gaming system 1.

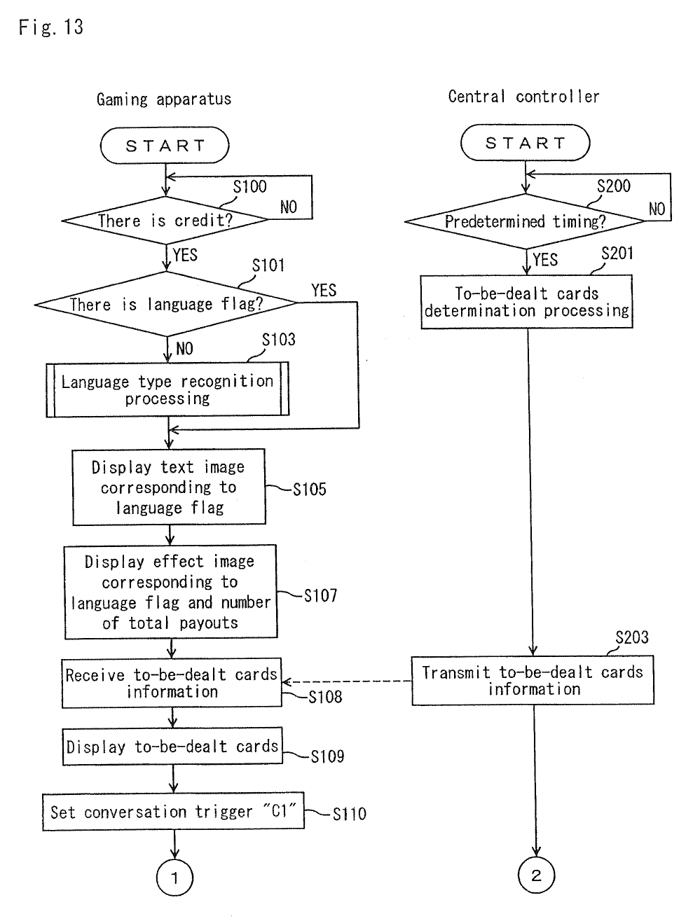

FIGS. 13 to 18 are flow charts illustrating game processing according to the present embodiment.

First, the CPU 51 determines whether or not there is remaining a credit (step S100). When determining that there is not remaining the credit, the CPU 51 returns the processing to step S100. Here, in the present embodiment, a coin can be inserted to the coin insertion slot 13 at an optional timing. When determining that the inserted-coin detecting section 68 detects a coin, the CPU 51 stores a credit corresponding to the inserted coin by adding to the credit being stored in the RAM 52.

When determining that there is remaining the credit in step S100, the CPU 51 determines whether or not the language flag is set (step S101).

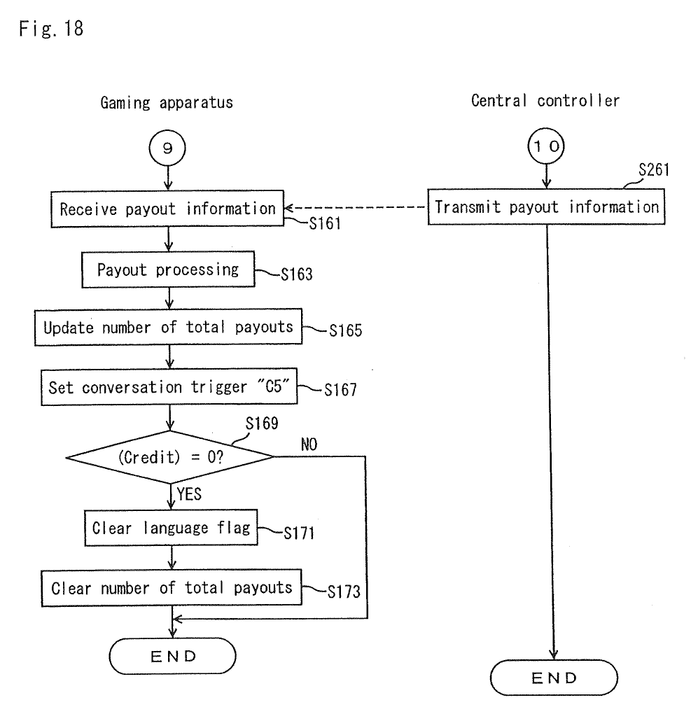

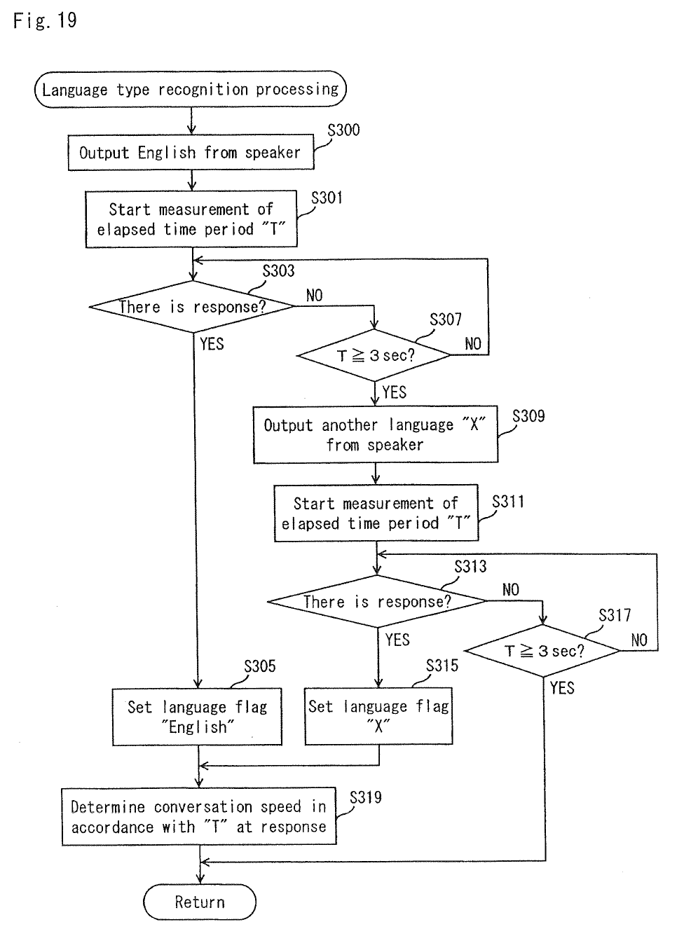

When determining that the language flag is not set, the CPU 51 conducts the language type recognition processing (step S103). In the processing, the CPU 51 outputs various languages such as English and Japanese from the speakers 16 (see FIG. 5) one by one. Then, the CPU 51 determines to which language there is a response from the microphone 17 (see FIG. 5), and thereby determining a language type. Thereafter, a language flag corresponding to the determined language type is set in the RAM 52. Here, a detail of the language type recognition processing will be described later with reference to FIG. 18 and FIG. 19.

When determining that the language flag is not set in step S101 or after conducting the processing of step S103, the CPU 51 displays a text image corresponding to the language flag to the liquid crystal display 10 (step S105). In the processing, for example, the CPU 51 displays the text image 77 (for example, see FIG. 12A) in English in the case that the language flag is “English”, and displays the text image in Japanese in the case that the language flag is “Japanese”.

Next, in step S107, the CPU 51 displays an effect image corresponding to the language flag to the liquid crystal display 10. In the processing, for example, the CPU 51 displays an image of a chess piece (for example, see the GRADE image 78A in FIG. 12A) in the case that the language flag is “English”, and displays an image of a shogi piece in the case that the language flag is “Japanese”. As above described, the CPU 51 reads image data corresponding to the language flag and displays an image based on the read image data to the liquid crystal display 10.

At this time, the CPU 51 displays various images to the liquid crystal display 10 according to the number of total payouts. More specifically, in the case that the language flag is “English” and the number of total payouts is 999 or less, for example, the CPU 51 displays a GRADE image (see the GRADE image 78A in FIG. 12A) showing the Pawn piece as the GRADE image.

Further, in the case that the language flag is “English” and the number of total payouts is in the range of 1000 to 4999, the CPU 51 displays a GRADE image (see the GRADE image 78B in FIG. 12B) showing the Knight piece as the GRADE image.

Furthermore, in the case that the language flag is “English” and the number of total payouts is 5000 or more, the CPU 51 displays a GRADE image showing the King piece as the GRADE image.

As above described, the CPU 51 varies a type of a chess piece to be displayed as the GRADE image according to the number of total payouts, in the case that the language flag is “English”.

On the other hand, in the case that the language flag is “Japanese” and the number of total payouts is 999 or less, for example, the CPU 51 displays a GRADE image showing “Fu” of a shogi piece as the GRADE image.

Further, in the case that the language flag is “Japanese” and the number of total payouts is in the range of 1000 to 4999, the CPU 51 displays a GRADE image showing “Kin” of a shogi piece as the GRADE image.

Furthermore, in the case that the language flag is “Japanese” and the number of total payouts is 5000 or more, the CPU 51 displays a GRADE image showing “Ou” as the GRADE image.

After the processing of step S107, the CPU 51 waits for receiving to-be-dealt cards information from the CPU 41 included in the central controller 40. The to-be-dealt cards information is information on two cards to be dealt to the player and includes numbers or alphabets, and suits.

The CPU 41 included in the central controller 40 determines two cards to be dealt to the player, that is, the to-be-dealt cards information to be transmitted to each gaming apparatus 3, by using a random number, when a predetermined timing (for example, a timing that one minute has elapsed since the last game is ended) has come (step S201).

Next, the CPU 41 transmits the to-be-dealt cards information determined in step S201 to each gaming apparatus 3 (step S203).

On the other hand, the CPU 51 included in the gaming apparatus 3 displays, upon receiving the to-be-dealt cards information from the CPU 41 in the central controller 40 (step S108), two cards to the liquid crystal display 10 based on the received to-be-dealt cards information in step S109 (for example, see FIG. 12A).

Next, in step S111, the CPU 51 sets the conversation trigger C1 in the RAM 52. As a result of the conversation trigger C1 being set in the RAM 52, a conversation based on the to-be-dealt cards being dealt is started in the gaming apparatus 3. Here, processing relating to the conversation will be described later with reference to FIG. 23.

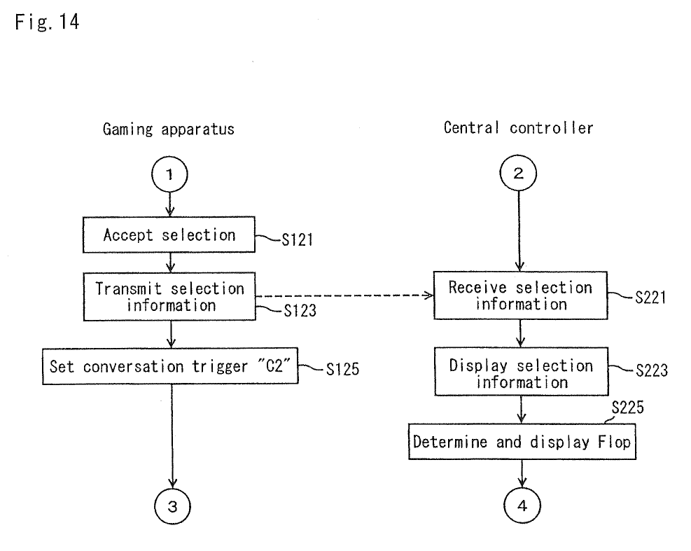

Next, in step S121 in FIG. 14, the CPU 51 accepts the bet selection. In this step, the player conducts a bet selection on the touch panel 11.

In step S123, the CPU 51 conducts processing of subtracting a credit corresponding to the betted coin from the credit being stored in the RAM 52, concurrently with transmitting information on the bet selection inputted by the player (selection information) to the CPU 41. The selection information includes information on the number of coins betted by the player.

In step S125, the CPU 51 sets the conversation trigger C2 in the RAM 52. As a result of the conversation trigger C2 being set in the RAM 52, a conversation based on the player's selection of bet, call, raise or fold is started in the gaming apparatus 3.

On the other hand, the CPU 41 included in the central controller 40 displays, upon receiving the selection information transmitted from the CPU 51 (step S221), the received selection information to the gaming information display portion 35 in the front display 21 (step S223), and cumulatively adds the number of credits corresponding to the betted coins to the number of credits stored in the RAM 42. Next, the CPU 41 determines three cards, which are to be Flop, and displays the cards to the front display 21 (step S225).

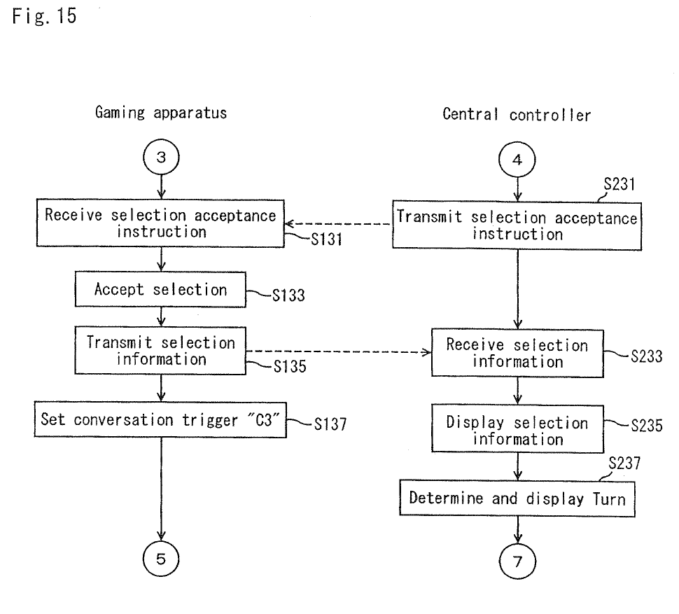

Next, in step S231 in FIG. 15, the CPU 41 transmits to the CPU 51 a signal for instructing an acceptance of the bet selection (selection acceptance instruction signal).

On receiving the selection acceptance instruction signal (step S131 in FIG. 15), the CPU 51 included in the gaming apparatus 3 accepts the bet selection (step S133), transmits the selection information to the CPU 41 (step S135) and subtracts a credit corresponding to a betted coin from the credit being stored in the RAM 52.

Next, in step S137, the CPU 51 sets the conversation trigger C3 in the RAM 52. As a result of the conversation trigger C3 being set in the RAM 52, a conversation based on the player's selection of bet, call, raise or fold is started in the gaming apparatus 3.

On the other hand, upon receiving the selection information transmitted from the CPU 51 (step S233), the CPU 41 included in the central controller 40 displays the received selection information to the gaming information display portion 35 in the front display 21 (step S235), and cumulatively adds the number of credits corresponding to the betted coins to the number of credits stored in the RAM 42. Next, the CPU 41 determines a card, which is to be Turn, and displays the card to the front display 21 (step S237).

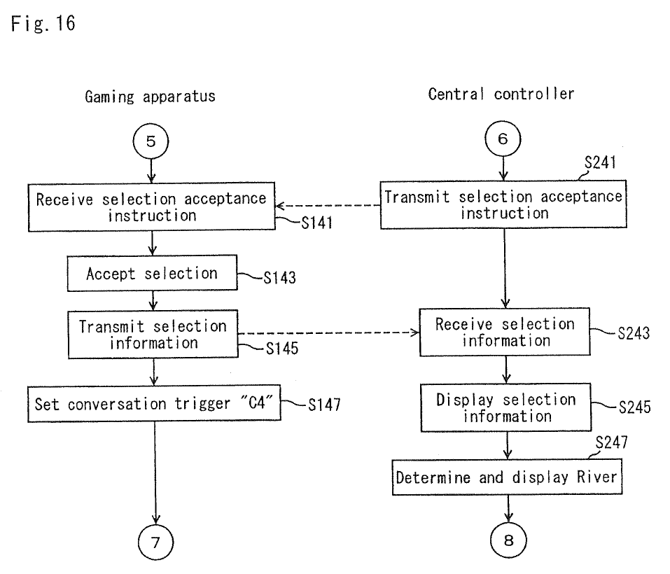

Next, the CPU 41 transmits the selection acceptance instruction signal to the CPU 51 in step S241 in FIG. 16.

On receiving the selection acceptance instruction signal (step S141 in FIG. 16), the CPU 51 included in the gaming apparatus 3 accepts the bet selection (step S143), transmits the selection information to the CPU 41 (step S145) and subtracts a credit corresponding to the betted coin from the credit being stored in the RAM 52.

Next, in step S147, the CPU 51 sets the conversation trigger C4 in the RAM 52. As a result of the conversation trigger C4 being set in the RAM 52, the conversation based on the player's selection of bet, call, raise or fold is started in the gaming apparatus 3.

On the other hand, upon receiving the selection information transmitted from the CPU 51 (step S243), the CPU 41 included in the central controller 40 displays the received selection information to the gaming information display portion 35 in the front display 21 (step S245), and cumulatively adds the number of credits corresponding to the betted coins to the number of credits stored in the RAM 42. Then, the CPU 41 determines a card, which is to be River, and displays the card to the front display 21 (step S247).

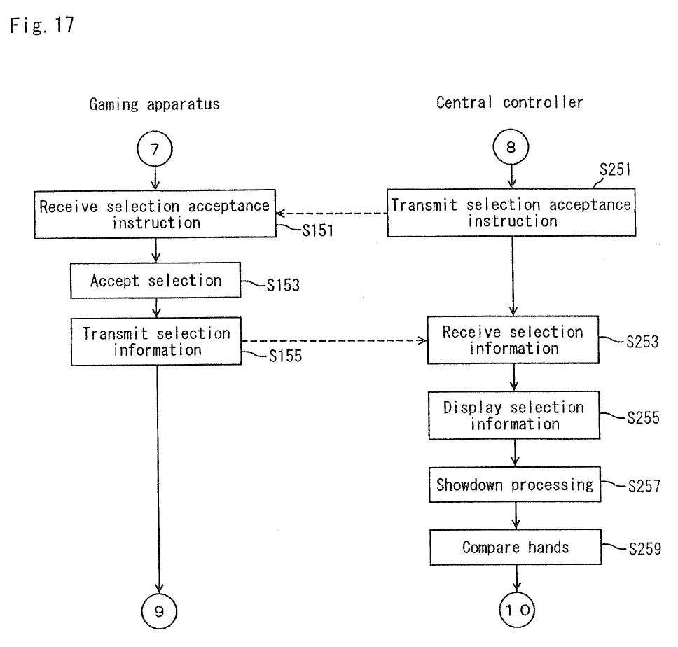

Next, in step S251 in FIG. 17, the CPU 41 transmits the selection acceptance instruction signal to the CPU 51.

Upon receiving the selection acceptance instruction signal (step S151 in FIG. 17), the CPU 51 included in the gaming apparatus 3 accepts a bet selection (step S153), transmits the selection information to the CPU 41 (step S155) and subtracts a credit corresponding to the betted coin from the credit being stored in the RAM 52.

On the other hand, upon receiving the selection information transmitted from the CPU 51 (step S253), the CPU 41 included in the central controller 40 displays the received selection information to the gaming information display portion 35 in the front display 21 (step S255), and cumulatively adds the number of credits corresponding to the betted coins to the number of credits stored in the RAM 42.

Next, in step S257, the CPU 41 conducts showdown processing. More specifically, the CPU 41 displays two cards dealt to the player on each gaming apparatus 3 to the gaming information display portion 35 corresponding to each gaming apparatus 3.

Next, in step S259, the CPU 41 compares hands. More specifically, the CPU 41 determines the strongest hand as a hand of a single player, out of the hands which can be established by combining two cards dealt to the player and three cards among five cards displayed to the table 31 in the front display 21. After conducting the same processing with respect to all the players remaining in the game, the CPU 41 determines the player having the strongest hand by comparing the hands of the respective players.

Next, in step S261 in FIG. 18, the CPU 41 transmits information on the number of payouts (hereinafter, also referred to as payout information) to the CPU 51. More specifically, the CPU 41 transmits information on an amount of the credit cumulatively stored in the RAM 42 to the CPU 51. After conducting the processing of step S261, the CPU 41 terminates the game processing according to the central controller 40.

Upon receiving the payout information (step S161), the CPU 51 included in the gaming apparatus 3 pays out a credit based on the received payout information (step S163). Here, in the case that the operation button 12 is pressed, the CPU 51 pays out coins in number corresponding to the number of credits stored in the RAM 52 from the coin payout exit 15.

Next, in step S165, the CPU 51 updates the number of total payouts. In the processing, the CPU 51 adds the number of paid out credits to the number of total payouts.

Next, in step S167, the CPU 51 sets the conversation trigger C5 in the RAM 52. As a result of the conversation trigger C5 being set in the RAM 52, a conversation based on a single game being ended is started in the gaming apparatus 3.

Next, in step S169, the CPU 51 determines whether or not the credit is zero. When determining that the credit is not zero, the CPU 51 terminates the game processing according to the gaming apparatus 3.

When determining that the credit is zero, the CPU 51 clears the language flag (step S171). Next, the CPU 51 clears the number of total payouts. Then, the CPU 51 terminates the game processing according to the gaming apparatus 3.

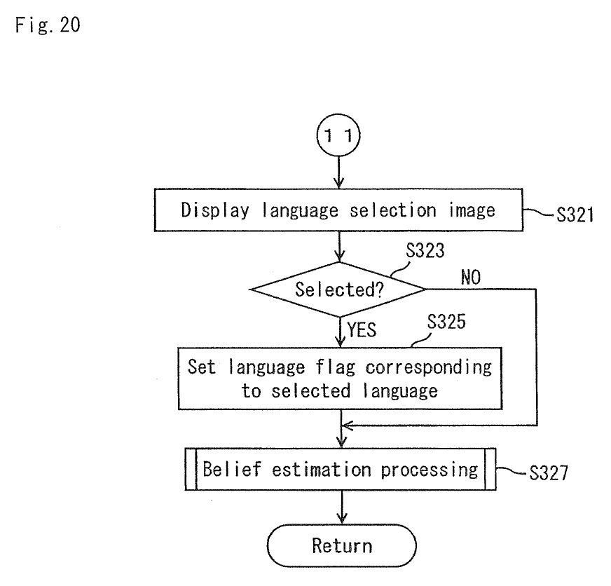

FIG. 19 and FIG. 20 are flow charts illustrating a language type recognition processing according to the present embodiment.

The language recognition program stored in the ROM 53 is read and executed so as to advance the language type recognition processing.

First, the CPU 51 outputs “Hello” in English from the speakers 16 (step S 300) and starts measurement of the elapsed time period T (step S301).

Next, in step S303, the CPU 51 determines whether or not a response to “Hello” is inputted from the microphone 17. In the processing, the CPU 51 determines, for example, whether or not “Hello” is inputted from the microphone 17. When determining that a response to “Hello” is inputted from the microphone 17, the CPU 51 stores the language flag of “English” in the language flag storage area 52A (see FIG. 7) in the RAM 52 (step S305).

When determining that a response to “Hello” is not inputted from the microphone 17, the CPU 51 determines whether or not the elapsed time period T exceeds three seconds (step S307). When determining that the elapsed time period T is not exceeding three seconds, the CPU 51 returns the processing to step S303.

When determining that the elapsed time period T is exceeding three seconds, the CPU 51 outputs a voice corresponding to “Hello” in another language “X” (for example, “Japanese”) from the speakers 16 (step S309), and starts measurement of the elapsed time period T (step S311).

Next, in step S313, the CPU 51 determines whether or not a response to “Hello” in another language “X” is inputted from the microphone 17. In the processing, the CPU 51 determines, for example, whether or not “Hello” in another language “X” is inputted from the microphone 17. When determining that a response to “Hello” in another language “X” is inputted from the microphone 17, the CPU 51 stores a language flag “X” in the language flag storage area 52A (see FIG. 7) in the RAM 52 (step S315).

When determining that a response to “Hello” in another language “X” has not been inputted from the microphone 17, the CPU 51 determines whether or not the elapsed time period T exceeds three seconds (step S317). When determining that the elapsed time period T is not exceeding three seconds, the CPU 51 returns the processing to step S313.

After the processing of step S305 or after the processing of step S315, the CPU 51 determines the conversation speed corresponding to the elapsed time period T at the time when the response is inputted (step S319). In the processing, the CPU 51 determines the conversation speed with reference to the conversation speed determination table (see FIG. 9) stored in the ROM 53. Then, the CPU 51 stores information on the determined conversation speed in the conversation speed storage area 52C (see FIG. 7) in the RAM 52.

When determining that the elapsed time period T is exceeding three seconds in step S317 or after the processing of step S319, the CPU 51 displays the language selection image to the liquid crystal display 10 (step S321).

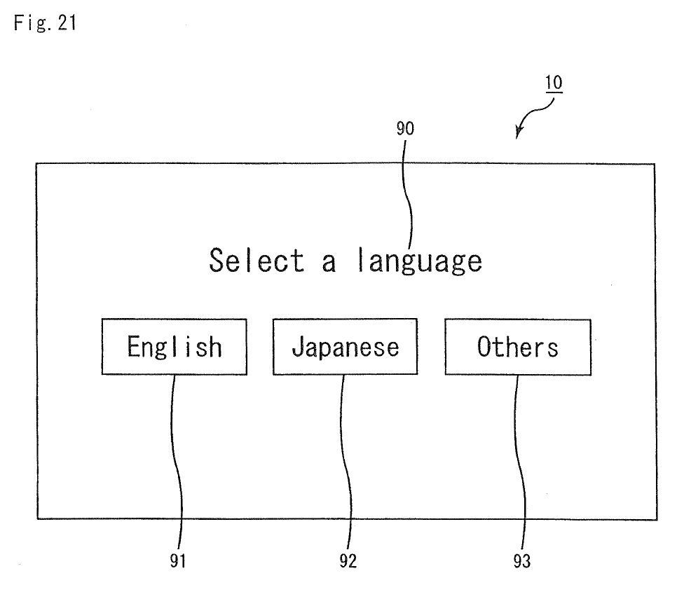

FIG. 21 is an exemplary view showing an image displayed to the liquid crystal display included in the gaming apparatus shown in FIG. 5.

The image shown in FIG. 21 is the language selection image displayed in the processing of step S321. As shown in FIG. 21, to the center part of the liquid crystal display 10, there is displayed an image 90 showing an instruction to select a language type. Further, below the image 90, an English selection image 91 for selecting English as the language type, a Japanese selection image 92 for selecting Japanese as the language type and an Others selection image 93 for selecting a language other than English and Japanese are displayed starting from the left. The player can select the language type by touching a corresponding part on the touch panel 11. Here, in the present embodiment, the language selection image includes the image 90, the English selection image 91, the Japanese selection image 92 and the Others selection image 93. Further, a selection image maybe an image using a corresponding language. That is, “Japanese” shown in the Japanese selection image 92 may be displayed in Japanese.

After the processing of step S321, the CPU 51 determines whether or not there has been a selection input (step S323). In the processing, the CPU 51 determines whether or not a contact by the player is detected from the touch panel 11 during a predetermined time period (for example, five seconds) since the language selection image is displayed. The touch panel 11 corresponds to the input device according to the present invention. When determining that there has been the selection input, the CPU 51 stores the language flag corresponding to the selected language type in the language flag storage area 52A (see FIG. 7) in the RAM 52 (step S325). For example, upon detecting a contact by the player to the part corresponding to the English selection image 91 (see FIG. 21) on the touch panel 11, the CPU 51 stores the language flag “English”. Further, upon detecting a contact by the player to the part corresponding to the Japanese selection image 92 (see FIG. 21) on the touch panel 11, for example, the CPU 51 stores the language flag “Japanese”.

Here, when detecting a contact by the player to the part corresponding to the Others selection image 93, the CPU 51 further displays selection images for selecting French, German and the like. Then, when detecting a contact by the player to a part corresponding to a newly displayed selection image, the CPU 51 stores a language flag corresponding to the language in the language flag storage area 52A (see FIG. 7) in the RAM 52.

After the processing of step S325 or when determining that there has not been a selection input in step S323, the CPU 51 conducts belief estimation processing (step S327) and terminates the present subroutine.

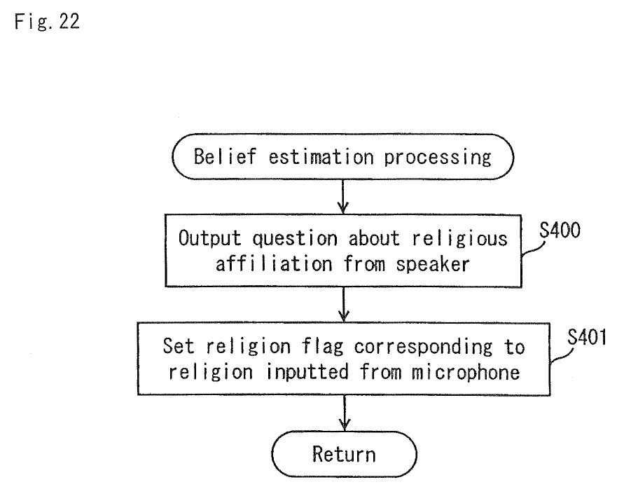

FIG. 22 is a flow chart illustrating belief estimation processing according to the present embodiment.

First, the CPU 51 outputs a question about a religious affiliation from the speakers 16 in step S400. In the processing, the CPU 51 outputs, for example, a voice saying “What is your religious affiliation?” from the speakers 16.

Next, in step S401, the CPU 51 stores a religion flag corresponding to the religion, which is inputted from the microphone 17 and recognized, in the belief storage area 52D (see FIG. 7) in the RAM 52. Then, the CPU 51 terminates the present subroutine.

The CPU 51 refers to the religion flag when displaying an image according to the conduct of the game processing (see FIGS. 13 to 18). The CPU 51 omits display of an image, of which display is restricted by the religion flag.

FIG. 23 is a flow chart illustrating conversation processing according to the present embodiment.

The conversation program stored in the ROM 53 is read and executed so as to advance the conversation processing. Further, the conversation processing is a processing called and conducted at a predetermined timing separately from the game processing (see FIGS. 13 to 18).

Here, the conversation processing is conducted in the language corresponding to the language flag stored in the language flag storage area 52A in the RAM 52. Further, the conversation processing is conducted at a speed corresponding to information on the conversation speed stored in the conversation speed storage area 52B in the RAM 52.

First, in step S500, the CPU 51 determines whether or not a conversation trigger is stored in the conversation trigger storage area 52B in the RAM 52. In the processing, the CPU 51 determines whether or not any of the conversation triggers, out of the conversation triggers C1, C2, C3, C4 and C5, is stored in the RAM 52. When determining that the conversation trigger is not stored in the RAM 52, the CPU 51 terminates the present subroutine.

When determining that the conversation trigger is stored in the RAM 52 in step S500, the CPU 51 outputs a voice corresponding to the conversation trigger with reference to the conversational sentence selection table stored in the ROM 53 (step S501). At this time, the CPU 51 outputs the conversational sentence from the speakers 16 after determining the to-be-outputted conversational sentence with reference not only to the conversational sentence selection table, but also to the selection information and to the gaming history according to need.

Next, in step S503, the CPU 51 recognizes a voice inputted from the microphone 17. Then, according to the recognized voice (conversational content), the CPU 51 outputs a voice corresponding to the recognized content from the speakers 16, and carries the conversation with the player on by recognizing the voice inputted from the microphone 17 (step S505).

Next, in step S507, the CPU 51 determines whether or not there is a new conversation trigger being set or the conversation trigger being cleared. In the case that a new conversation trigger is not set and the conversation trigger is not cleared, the CPU 51 returns the processing to step S505 and continues the conversation. On the other hand, in the case that a new conversation trigger is set or the conversation trigger is cleared, the CPU 51 terminates the present subroutine.

Accordingly, the CPU 51 starts a conversation when a conversation trigger is set, starts another conversation on a new topic when a new conversation trigger is set, and terminates the conversation when the conversation trigger is cleared.

As above described, according to the gaming apparatus 3 and the control method of the gaming apparatus 3, a language type is recognized from a sound inputted from the microphone 17. Then, a text image corresponding to the recognized language type is displayed to the liquid crystal display 10 according to the progress of the game. Namely, a text recognizable to a player is displayed to the liquid crystal display 10 according to the progress of the game. Accordingly, compared to a case where a text in an unrecognizable language for the player is displayed, the player can understand more the progress of the game and a content of a game effect, so that the player can enjoy the game more.

Further, the conversation is conducted in the recognized language, and therefore, the player can play the game while enjoying the conversation. Particularly, on the gaming apparatus 3 providing a game played by a single player (game not advanced by cooperation with another player) as in the present embodiment, it is highly possible that the player feels loneliness. However, by conducting a conversation, it becomes possible to dispel the loneliness.

As above described, according to the gaming apparatus 3 and the control method of the gaming apparatus 3, it becomes possible to provide a sophisticated service by installing a conversation program on a gaming apparatus.

Further, in the case that a conversation program is installed on the gaming apparatus 3, a problem is how to specify the language type. However, according to the gaming apparatus 3 and the control method of the gaming apparatus 3, a language type is recognized from a sound inputted from the microphone 17, so that a conversation can be started smoothly. Particularly, it is possible to surprise a player who does not know that a conversation is to be conducted, by talking to suddenly.

Further, according to the gaming apparatus 3 and the control method of the gaming apparatus 3, a language type is recognized by an input from the input device (touch panel 11), so that a possibility of displaying an image corresponding to a language type that the player cannot understand is extremely low.

Furthermore, according to the gaming apparatus 3 and the control method of the gaming apparatus 3, a time period between the output of the voice relating to the conversation from the speakers 16 and the input of a response to the microphone 17 is measured. A voice at a speed corresponding to the measured time period is outputted, and the conversation with the player is conducted by recognizing a voice inputted from the microphone 17. As above described, a conversation is conducted at a speed corresponding to the conversation speed of the player, and therefore, the player can enjoy a more comfortable conversation.

In the present embodiment, there has been described a case where a controller (CPU) which conducts the game processing also conducts the conversation processing. However, the present invention is not limited to this example. A controller (CPU) for conducting the game processing and a controller (CPU) for conducting the conversation processing may be provided separately. In such a configuration, the controller for conducting the conversation processing may receive various kinds of information (for example, information on the selection information, the gaming history, the language flag, the conversation trigger and the conversation speed, information on the player's belief, the number of total payouts and the like) from the controller for conducting the game processing, and may conduct the conversation processing based on these information.

In the present embodiment, there has been described a case where the text image 77 (text image indicating that the GRADE image 78 is “YOUR GRADE”) is displayed in a text corresponding to the recognized language type. However, the present invention is not limited to this example. In the present invention, any images displayed to the display (liquid crystal display 10) may be displayed in the text corresponding to the recognized language type.

In the present invention, various images (for example, effect image) according to the conversation speed may be displayed. Namely, various images may be displayed according to the measurement result of the time period between an output of the voice relating to the conversation and an input of a response thereto to the microphone. For example, in the case of the setting of a slow conversation speed, a character in an old animation may be displayed, while in the case of the setting of a fast conversation speed, a character in a comparatively new animation may be displayed. It is highly possible that the player allocated with the setting of a slow conversation speed is elderly, while it is highly possible that the player allocated with the setting of a fast conversation speed is young. Therefore, an image more suitable for the player's age can be displayed, so that it becomes possible to entertain the player more.

Although the embodiments of the present invention have been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processes to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming apparatus comprising:
a microphone;
a speaker;
a display;
a memory storing text data for each language type; and
a controller,
said controller programmed to conduct the processing of:
(A) recognizing a language type from a sound inputted from said microphone by executing a language recognition program;
(B) conducting a conversation with a player by recognizing a voice inputted from said microphone, in addition to outputting a voice from said speaker by executing a conversation program corresponding to the language recognized in said processing (A); and
(C) displaying to said display a text based on text data corresponding to the language type recognized in said processing (A) according to progress of a game, said text data read from said memory.

2. The gaming apparatus according to claim 1,
wherein
said controller is further programmed to conduct the processing of
(D) measuring a time period between the output of the voice relating to the conversation from said speaker and an input of a response to said microphone, and
said processing (B) is processing of
conducting the conversation with the player by recognizing a voice inputted from said microphone, in addition to outputting a voice at a speed corresponding to the time period measured in said processing (D).

3. A gaming apparatus comprising:
a microphone;
a speaker;
a display;
a memory storing text data for each language type;
an input device; and
a controller,
said controller programmed to conduct the processing of:
(A) recognizing a language type from an input from said input device;
(B) conducting a conversation with a player by recognizing a voice inputted from said microphone, in addition to outputting a voice from said speaker by executing a conversation program corresponding to the language recognized in said processing (A); and
(C) displaying to said display a text based on text data corresponding to the language type recognized in said processing (A) according to progress of a game, said text data read from said memory.

4. The gaming apparatus according to claim 3,
wherein
said controller is further programmed to conduct the processing of
(D) measuring a time period between the output of the voice relating to the conversation from said speaker and an input of a response to said microphone, and
said processing (B) is processing of
conducting the conversation with the player by recognizing a voice inputted from said microphone, in addition to outputting a voice at a speed corresponding to the time period measured in said processing (D).

5. A control method of a gaming apparatus, the control method comprising the step of:
(A) recognizing a language type from a sound inputted from a microphone by executing a language recognition program;
(B) conducting a conversation with a player by recognizing a voice inputted from the microphone, in addition to outputting a voice from a speaker by executing a conversation program corresponding to the language recognized in said step (A); and
(C) displaying to a display a text corresponding to the language type recognized in said step (A) according to progress of a game.

6. A control method of a gaming apparatus, the control method comprising the step of:
(A) recognizing a language type by an input from the input device;
(B) conducting a conversation with a player by recognizing a voice inputted from a microphone, in addition to outputting a voice from a speaker by executing a conversation program corresponding to the language recognized in said step (A); and
(C) displaying to a display a text corresponding to the language type recognized in said step (A) according to progress of a game.
